(19) United States
(12) Patent Application Publication
(10) Pub. No.: US 2026/0029311 A1
(43) Pub. Date: Jan. 29, 2026

(54) METHOD FOR DETERMINING THE CONDITION OF AN OPERATING MEDIUM IN A MACHINE, AND DEVICE DESIGNED TO CARRY OUT THE METHOD

(71) Applicant: Rolls-Royce Solutions GmbH, Friedrichshafen (DE)

(72) Inventors: Horst Weidele, Meersburg (DE); Thomas Kottke, Ehningen (DE); Marcel Fouquet, Markdorf (DE); David Rupp, Berg (DE); Annette Osiecki, Friedrichshafen (DE)

(73) Assignee: Rolls-Royce Solutions GmbH, Friedrichshafen (DE)

(21) Appl. No.: 19/279,085

(22) Filed: Jul. 24, 2025

(30) Foreign Application Priority Data
Jul. 25, 2024 (DE) 10 2024 121 265.9

(51) Int. Cl. G01M 99/00

(52) U.S. Cl. CPC G01M 99/005

(57) ABSTRACT

A method to determine a condition of an operating medium in a machine includes the steps of: supplying the operating medium to a spectroscopy device coupled to the machine; performing a spectroscopic measurement analysis by a test radiation of the spectroscopy device; determining a spectroscopic measurement result based on the spectroscopic measurement analysis; and setting the spectroscopic measurement result in relation to a measurement reference, with the result that an evaluable measurement signal is issued, wherein the spectroscopic measurement result is repeatedly determined over a predetermined reference operating period following an initial event with regard to the operating medium specifying spectroscopic measurement results assigned to the predetermined reference operating period, and the measurement reference is determined from the spectroscopic measurement results, and the evaluable measurement signal is repeatedly specified over an operating time of the machine such that a specific condition characteristic for the operating medium can be signaled.

### CROSS REFERENCE TO RELATED APPLICATIONS

This claims priority to German patent application no. 10 2024 121 265.9, filed Jul. 25, 2024, which is incorporated herein by reference.

### BACKGROUND OF THE INVENTION

### 1. Field of the Invention

The present invention relates to determining a condition of an operating medium.

### 2. Description of the Related Art

A method for detecting the oil condition of an operating oil in an engine of an internal combustion engine is described in DE 10 2020 126 900 A1. An oil supply system with an oil filter for the operating oil and an oil differential pressure measuring device is designed to detect an oil pressure difference or, as the case may be, oil pressure relationship of the operating oil via the oil filter in the oil supply system. On this basis, a number of relationship variable values are assigned to a trend development over operating time points.

In addition, it is known to analyze the operating medium, in particular oil samples, in a laboratory by way of infrared spectrographs in order to be able to assess, for example, aging of the operating medium, whereby a comparison sample of the fresh operating medium is required.

Moreover, sensor systems are known from the state of the art that are also based on the infrared spectrographic method but do not have the wavelength range of laboratory devices. To determine results, these sensor systems work with comparison samples of operating medium from the laboratory and determine the values of the individual substances based on the comparison of the actual state with the target state. This relates to characteristic properties of the operating medium, for example acid or base number, particularly in the case of an operating oil. The comparison samples are measured using a reference measurement system in the laboratory, and the reference values are typically stored in a database in the sensor systems.

However, the use of comparison samples is difficult on machines that are in operation, such as internal combustion engines, especially on ships, because here typically types of operating mediums, especially oils, from different manufacturers are frequently mixed. Also, these comparison samples are often unavailable, or the composition of a particular type of operating medium, especially oil, has changed over time (i.e. due to additive adjustments).

Furthermore, determination of the condition with regard to a reliable statement for the further operation of the machine, which is operated using operating mediums, is quite challenging and also system-critical. Relevant measurement methods for detecting and issuing reliable information regarding the necessity to replace operating mediums are thus comparatively complex.

In DE 20 2007 019 631 U1 it is explained that the degree of wear of an oil, especially an engine oil, can be determined by way of infrared spectroscopy. In the mid-infrared range, absorption bands are found that are characteristic of the acid content, alcohol content, or water content. In particular, a spectral range characteristic of the water content of a lubricating oil is found in the 2900-3000 nm range. Thus, the water content can be determined by infrared fluoroscopy of a lubricating oil. A device for determining the water content in mineral oils and similar liquids with a specific base number and a specific degree of blackening is described. The device uses an infrared measuring cell through which the mineral oil that is to be analyzed flows continuously in a measuring channel, and whose initial measured value, at a selected spectral value provides a measure of the water content in the mineral oil. For determination of the condition of an operating oil in a machine, this document provides that an infrared measuring cell is designed as a flow-through cuvette, in which an infrared beam penetrating the flow-through cuvette is detected by an infrared receiver, wherein the initial measured value of the infrared measuring cell is related by way of a computing unit to a stored base value which was obtained by alternating the measurement of the mineral oil to be examined by way of the infrared measuring cell and at certain time intervals from the measurement of a reference mineral oil flowing through a flushing channel.

The initial measured value is calibrated by way of the computing unit and a first correction value that is derived from the respective base number of the mineral oil being analyzed. A white-light-sensitive photodetector is provided to detect the degree of blackening in the mineral oil being analyzed. A second correction value is derived from the detected degree of blackening, which is then mathematically linked to the recorded water content of the mineral oil being analyzed.

Based on the known sensor systems explained at the beginning, in particular as discussed in the aforementioned DE 20 2007 019 631 U1, IR-based operating medium condition monitoring systems, in particular operating oil condition monitoring systems, have hitherto always assumed a reference value, which is either recorded as a calibration value in a database or must be carried separately, as in the aforementioned utility model.

The extensive effort required to maintain the database with every operating medium used, especially operating oil, and its parameters represent a problem. Furthermore, an unknown or undefined operating medium, especially an unknown or undefined operating oil, cannot be used.

Particular problems arise with changing types of operating medium, especially types of operating oil, as occurs in the field, either due to refilling of operating medium or due to a change in operating medium. This is also problematic in load dependent or environmentally dependent conditions. This is particularly the case if only a relatively static reference value of a condition of the operating medium is detected. In this case, an operating medium condition can only be declared critical when engine damage is already imminent.

What is needed in the art is a method and a device, in particular including a monitoring device for determining the state of an operating medium located in a machine, by way of which a condition of the operating medium can be detected more flexibly and with less effort, optionally more reliably or at least in a timely manner. The method and the device are to include methods by way of which an operating medium condition in a machine or in a system, or respectively a method for monitoring an operating medium condition in an improved manner. In particular, a suitably designed controller, in particular a control and measuring device, should include control modules by way of which a warning and/or alarm conditions for an operating medium present in the machine can be detected more flexibly and with less effort, and at the same time, more reliably or at least in a timely manner.

### SUMMARY OF THE INVENTION

The invention relates to a method to determine the condition of an operating medium in a machine, in particular of an operating oil or a coolant, in particular with an operating medium change detection or detection of an initial event or another event. The invention also relates to a device, optionally a control and measuring device for a machine or a machine equipped with the control and measuring device, designed to carry out the method.

The present invention provides in a first aspect a method for determining the condition of an operating medium located in a machine, in particular with an operating medium change detection or similar type of detection of an initial event or another event, the method including the following steps:
supplying the operating medium for the machine to a spectroscopy device coupled to the machine;
performing a spectroscopic measurement analysis by way of a test radiation from the spectroscopy device;
determining a spectroscopic measurement result based on the spectroscopic measurement analysis; and
setting the spectroscopic measurement result in relation to a measurement reference so that from the relation an evaluable measurement signal is issued, wherein it is provided that
   the spectroscopic measurement result is repeatedly determined over a predetermined reference operating period following an initial event with regard to the operating medium, by specifying spectroscopic measurement results assigned to the reference operating period, and the measurement reference is determined from the spectroscopic measurement results, and
   the evaluable measurement signal is repeatedly specified over an operating time of the machine in such a way that a specific condition characteristic for the operating medium can be signaled.

The present invention also provides a second aspect by a device designed to carry out the method.

The invention relates in particular to a control and measuring device for a machine.

The invention relates in particular to a machine that includes a control and measuring device.

In particular, the aforementioned method according to the present invention and the device, analogously, utilize operating medium change detection or similar detection of an initial event or another event in an advantageous manner; the initial event can also be advantageously determined within the scope of a further development. The invention is further characterized by an advantageous procedure or a technical sequence and an evaluation approach that enable the measurement reference to be determined in an advantageous manner.

The present invention has recognized that the determination of the measurement reference can occur during machine operation or at least while the operating medium is in the machine. An initial event, for example a change of operating medium, is advantageously suited—as recognized by the present invention—to determine the measurement reference immediately afterward.

A measurement reference presumed required by the state of the art—and usually disadvantageously “static”—is no longer needed. The concept of the present invention provides that during operation, or at least while the operating medium is in the machine, a reference value is determined to indicate the measurement reference. This results in a determination of condition of an operating medium present in a machine becoming possible, by way of which an operating medium condition can be detected more flexibly and with less effort, however, optionally more reliably or at least in a timely manner.

A calibration, that is to be performed separately and separate from the machine, becomes completely or at least extensively unnecessary. Instead, based on the initial event, a reference operating period is used to determine one or a number of reference values after an operating medium change to determine the measurement reference. This leads moreover to a reliable measurement reference without the need for complex reference measurements or data.

It is apparent that-during operation or at least while operating medium is in the machine—the reference value determined to indicate the measurement reference is also able to relatively easily consider changing operating medium varieties or circumstances.

Since the measurement reference is more reliable, improved evaluation of the measurement signal can also occur advantageously over the machine's operating time. Thus, a database can be omitted; a change in the type of operating medium during an operating medium change is generally permissible and permits a reliable subsequent condition assessment. Besides, a preliminary chemical analysis of the operating medium, especially in a laboratory, can be omitted.

The machine is designed in particular in the embodiment of an internal combustion engine or a similar combustion engine, for example with an engine in the form of a diesel engine or gas or another Otto engine.

Within the scope of the present invention, operating mediums are understood to be fluids or substances in general, in particular liquids, for operating a machine, in particular for lubricating and/or cooling of components and/or sections of the machine. Within the scope of the present further development, operating mediums are understood to be operating oils and/or coolants, or operating mediums containing these. The operating medium is advantageously in the embodiment of an operating oil and/or a coolant.

Operating mediums are generally understood to be fluids or substances used in machine operation which can age or deteriorate, particularly those that remain in the machine over a relatively long operating period, i.e., operating mediums that are circulated. However, operating mediums with a relatively long dwell time in the machine, which are externally supplied or removed and which remain in the machine for a relatively long operating period, can also be affected.

It is advantageously provided that the spectroscopic measurement result is determined repeatedly for a reference number of repetitions, specifying a reference number of spectroscopic measurement results assigned to the reference operating period, and the reference operating period following the initial event with respect to the operating medium is determined such that the reference number of spectroscopic measurement results is within the reference operating period. Thus, in the immediate temporal follow-up to the initial event, it can be determined with advantage in which framework, that is, measurement scope and/or time scope, the measurement reference should be determined.

Advantageously it is checked that the spectroscopic measurement result is essentially unchanged for the reference number of repetitions, in particular that the reference number of spectroscopic measurement results is within a predetermined constant range, wherein the measurement reference is determined from the reference number of essentially unchanged spectroscopic measurement results of the reference operating time period. For example, this can be implemented by measuring a constant level of an intensity for a specific reference operating period. For this purpose, a few repetitions of determining spectroscopic measurement results are generally sufficient. For example, a leveling intensity value of a measurement spectrum of a measurement can be used as the reference intensity or reference spectrum to determine the measurement reference.

Advantageously, the spectroscopic measurement result is provided with test radiation of a predetermined spectrum for at least one test radiation line, for a number of test radiation lines, or for a spectrum band of the test radiation. For example, the spectroscopic measurement result can be an intensity obtained with the test radiation from the spectroscopic measurement analysis on the operating medium. The intensity can be spectrally resolved. Thus, a spectrum can be available as a spectroscopic measurement result, or at least a number of suitable or relevant spectroscopic test radiation lines at specific frequencies (or wavelengths) of same.

Typical possible measurement recordings with in-situ infrared spectrography concern, in particular, with an operating oil as the operating medium:
proportion of water;
oxidation, nitration and/or sulfation of proportions of the operating medium;
proportion of additives such as phenol;
proportion of additives such as ZDDP (zinc-dialkyldithiophosphate);
proportion of carbonates (especially for determining TBN);
proportion of aromatic phosphoric acid;
proportion of amine antioxidants;
degree of CH bending vibrations.

ZDDP (zinc dialkyldithiophosphate) is a medium that counters wear, especially in operating oil.

The TBN, or total base number, indicates the level of alkalinity in a lubricant, such as operating oil. TBN is a factor in controlling and managing the service life of oil. Using TBN helps to neutralize acids that form during operation. For example, crankcase oils should maintain an appropriate TBN level during operation to prevent acid buildup. Metal-containing detergent additives are a major source of TBN in a lubricant. Measuring TBN in engine oils is one important test. The central inorganic core of basic calcium carbonate/hydroxide, which is held in colloidal suspension in the lubricant by detergent soap molecules is thereby considered.

Along the same lines, measurement records can be specified using in-situ infrared spectrography, in particular for a coolant or other operating mediums.

The evaluable measurement signal is optionally provided transiently or continuously over a time period of machine operation.

The spectroscopic measurement result can be subjected to an optical filter and/or the evaluable measurement signal can be subjected to a numeric filter. Such measures increase the selectivity and improve the evaluability of the spectroscopic measurement result.

Within the scope of an especially optional further development, the evaluable measurement signal is presented as a progression over the operating time of the machine, whereby a specific condition of the operating medium can be signaled by way of the progression. This has the advantage that an analysis and an adjustment to alarm thresholds, and above all, error limits are possible in an improved manner. Events can also be identified more effectively based on a progression, which may possibly be interpolated between individual measurement results.

Optionally, the initial event in relation to the operating medium is an initial event intended or suitable for determining the measurement reference; in particular, with respect to the operating medium, the initial event is selected from the group consisting of a change of operating medium, refilling of operating medium. An operating medium change can also be determined by being indicated externally. Within the scope of a further development, it is advantageously provided that the initial event with respect to the operating medium is determined by checking whether the measurement signal exhibits an erratic change for an event time window.

In particular, an erratic change amplitude assigned to the erratic change may exceed a first event threshold, in particular the initial event or an event generally being identified as an operating medium change. In particular, an erratic change amplitude assigned to the erratic change may exceed a second event threshold, in particular the initial event or an event generally being identified as operating medium refilling.

Within the scope of a further development, it is advantageously provided that the first event threshold exceeds the second event threshold. In other words, this recognizes that a large jump in the measured data to values that move toward the new operating medium condition indicates a “change of operating medium”, whereas a small jump to better measured values-toward the new operating medium condition-means that “operating medium has been refilled.”

If the initial event or an event in general is detected, it is advantageously provided that
at least one operating time specification for the event time window is recorded; and/or
at least one spectrally selective information of the spectroscopic measurement result is recorded for the evaluable measurement signal for the event time window.

The at least one spectrally selective information is optionally evaluated with regard to the predetermined spectrum of the test radiation.

The test radiation can in particular include a test radiation line or a measuring spectrum band, relating to one or a number of the parameters selected from the group consisting of: spectral position, spectral width, amplitude, gradient and phase of the test radiation, and relations of the parameters to one another, in particular relations of different spectral positions.

The at least one spectrally selective information is optionally selective for additives, in particular zinc, barium, boron, calcium, magnesium or phosphorus, and/or sulfates or chemical compounds in the operating medium, in particular in the operating oil.

The test radiation is advantageous in the infrared (IR) range of the optical spectrum. In other words, in particular directed at IR-active substances, especially in the range between 700 nm and 12 μm. The spectroscopic measurement analysis is not limited to, though optionally focused on, IR spectroscopy. In this respect, additional or alternative spectroscopic measurement analysis by way of X-ray, UV, VIS, NIR, or FIR spectroscopy is also possible; THz spectroscopy is also possible. The term spectroscopy is to be broadly defined as an investigation using electromagnetic radiation and is intended to make the events to be evaluated detectable.

In this respect, not only IR spectroscopy could be used, but also—additionally or alternatively—UV, VIS, NIR, or FIR spectroscopy. In this way, not only IR-active substances could be detected in the operating medium, but also—additionally or alternatively—non-IR-active substances, such as elements or non-IR-active molecules.

Metals, for example, may be less measurable with IR spectroscopy. For measuring molecular or lattice vibrations, FIR or THz spectroscopy is particularly suitable. Moreover, specific spectroscopic sensors for metal particles could be used; THz spectroscopy is particularly suitable for measuring lattice vibrations. THz spectroscopy is generally advantageously suitable for measuring volume flow, optionally in reflection. Also, spectroscopic sensors for particles smaller than approximately 300 micrometers could be used additionally or alternatively.

Within the scope of an especially optional further development, it is provided that an upper and/or lower error limit is specified for the repeatedly specified evaluable measurement signal over the operating period. In particular, the upper and/or lower error limit can advantageously be specified as an error limit progression based on a progression of the evaluable measurement signal over the operating time, which specifies an optional progression of the evaluable measurement signal.

The term “specifying an optional progression of the evaluable measurement signal” essentially refers to a general “tendency” or “trend.” This can optionally be precalculated based on the expected ageing of the operating oil. Mathematically, this can be implemented by way of a predicted or similarly assumed amplitude and with a gradient or possibly with a constant distance measure that should apply to a repeatedly specified, evaluable measurement signal over an operating period, in particular over its progression. The distance measure can be specified as a progression of averaged values or with an extrapolated limit curve. In this respect, “specifying an optional progression of the evaluable measurement signal” means a trend band to be assumed at best with a certain error deviation.

In the context of this further development, it was recognized in particular that a trend-based approach, i.e., a trend band including an upper and/or lower error limit, can consider normal operating medium ageing or influences—in terms of its level of separation from the actual progression; in other words, normally expected deviations and/or errors are considered. This could be, for example, a deviation due to water ingress during normal use or, also diesel ingress during normal use.

The spectroscopy device is advantageously part of a more complex measuring device. In particular, the measuring device can include an additional measuring unit, such as a measuring unit designed to determine temperature, viscosity, turbidity, or density of the operating medium.

In particular, the upper and/or lower error limit for the measurement signal can be determined based on a number of measurement parameters of the operating medium and/or the machine and/or operating environment of the machine. In particular, at least one additional operating condition parameter can be determined independently of the spectroscopic measurement result, in particular for the reference operating period, which is selected from the group consisting of: temperature, viscosity, turbidity, and density.

Within the scope of an especially optional further development, it is provided that the specific condition characteristic of the operating medium can be signaled with regard to an event selected from the group consisting of a change of operating medium, operating medium refill, an ingress of water into the operating medium, an ingress of fuel into the operating medium, an ingress of contamination and/or soot into the operating medium.

Embodiments of the invention are described below with reference to the drawings in comparison to the state of the art, some of which is also shown. These are not necessarily intended to be to scale, but, where useful for explanation, the drawings are schematic and/or slightly distorted. With regard to additions to the teachings immediately apparent from the drawings, reference is made to the relevant state of the art. It should be considered that numerous modifications and changes regarding the design and detail of an embodiment can be made without deviating from the general idea of the invention. The features of the invention disclosed in the description, the drawings and the claims can be essential, both individually and in any combination for further development of the invention. Moreover, all combinations of at least two of the features disclosed in the description, the drawings and/or the claims are within the scope of the invention.

The general idea of the invention is not limited to the exact form or detail of the optional embodiment shown and described below or limited to an object that would be limited compared to the object claimed in the claims. In the case of specified measurement ranges, values within the stated limits are also intended to be disclosed as limit values and can be used and claimed as desired. Additional advantages, features, and details of the invention become apparent from the following description of the optional embodiments and from the drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic of a machine being operated with a mineral oil, including a control and measuring system in an optional embodiment;

FIGS. 2A and 2B are such that FIG. 2A shows an exemplary signal progression over a reference operating time during an operating period of a machine which is operated using a mineral oil, after an initial event—in this case an oil change in an internal combustion engine, that is, a combustion engine-, wherein the initial event, in this case an oil change, is recognizable as an event in the signal progression and is used to determine the measurement reference, and FIG. 2B is a flow chart for a process sequence to determine the measuring frequency.

FIG. 3 is an exemplary signal progression over the operating time during an operating period of a machine—in this case an internal combustion engine, that is with a combustion engine-, which is operated with mineral oil, wherein certain events such as in the current case an oil change and an oil refill are recognizable in the signal progression as an event;

FIG. 4 is a flow chart for a first embodiment of a process sequence for oil change detection in a first variation;

FIG. 5 is an exemplary signal progression analogous to FIG. 3, wherein a water penetration is recognizable as an event in the signal progression and wherein the signal progression falls below a lower error limit of a trend band to issue a warning message;

FIG. 6A is a flow chart for a first embodiment of a process sequence to issue an alarm message;

FIG. 6B is a flow chart for a first embodiment of a process sequence to issue a warning message;

FIG. 7A, FIG. 7B each show an exemplary signal progression analogous to FIG. 5 with a trend band of error limits according to FIG. 7A and a recognizable event according to FIG. 7B in the signal progression which indicates engine damage and wherein the signal progression falls below a lower error limit of a trend band to issue a warning;

FIG. 8A, FIG. 8B each show an exemplary signal progression analogous to FIG. 1 with a trend band of error limits and wherein, in addition, a contaminant ingress (FIG. 8A) and an air ingress (FIG. 8B) is recognizable in the signal progression as an event and wherein the signal progression falls below a lower error limit of a trend band (FIG. 8A) or wherein the signal progression exceeds an upper error limit of a trend band (FIG. 8B) to issue a warning message;

FIG. 9 is a schematic detailed view of a control and measuring system, showing the functionality for determination of an oil condition according to an optional further development.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

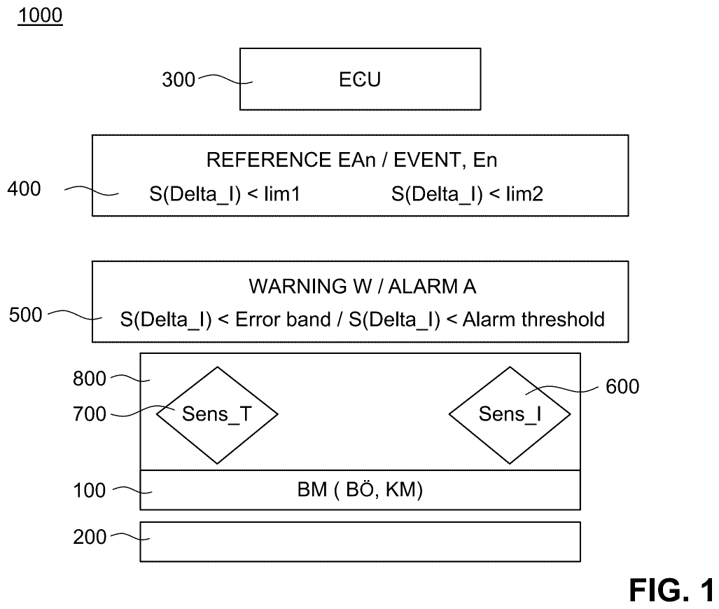

FIG. 1 schematically shows in an overview an optional embodiment of a device 1000 according to the concept of the invention as a system consisting of a control unit 300 and measuring device on a machine 100 and with a corresponding device 200 to signal or monitor, etc., to indicate or report a condition of an operating medium BM in the machine, such as a coolant KM or an operating oil BÖ.

Below, the concept of the invention is explained by way of a non-limiting design example for an operating oil BÖ in machine 100. It is therein to be understood that the described and optional features regarding an operating oil BÖ have proven to be especially relevant and advantageous within the framework of the concept of the invention. Nevertheless, it is to be understood that the features as described or analogously may also be relevant regarding another operating medium BM, such as a coolant KM, with the aforementioned advantages. On this basis, the concept of the invention is explained by way of the non-limiting design example for an operating oil BÖ in machine 100 and can also be applicable for other operating mediums BM, such as a coolant KM, in machine 100.

FIG. 1 illustrates schematically in detail the system of device 1000 with a machine 100, which is described herein in the context of an optional non-limiting embodiment based on an internal combustion engine. For lubrication of the engine and its components such as pistons, connecting rods, crankshafts, and camshafts the latter is operated primarily with an operating medium BM, in this case an operating oil BÖ. In principle, another machine which is to be operated with operating medium BM inside the machine may also be included within the concept of the invention. For example, the following description of the drawing applies equally to a processing machine or machines in the field of power generation and in addition or alternatively also to their gearboxes or gearboxes as such. Also, this type of machinery must be operated with operating medium BM located inside the machine, in particular, for the lubrication of rotating parts and, if necessary, also for bearings of the latter.

In the present case, machine 100 is equipped with a sensor system, which in this case relevantly includes a sensor system or similar analysis devices of a spectroscopy device 600, which, according to the present embodiment, includes at least one intensity sensor Sens_I.

In this design example, spectroscopy device 600 is advantageously part of a more complex measuring device 800. In particular, measuring device 800 may include an additional measuring unit, such as a measuring unit 700 designed for determination of a temperature, which in this case has a temperature sensor Sens_T. Other measuring units which are designed to determine the viscosity, turbidity or density of operating medium BM may also be provided.

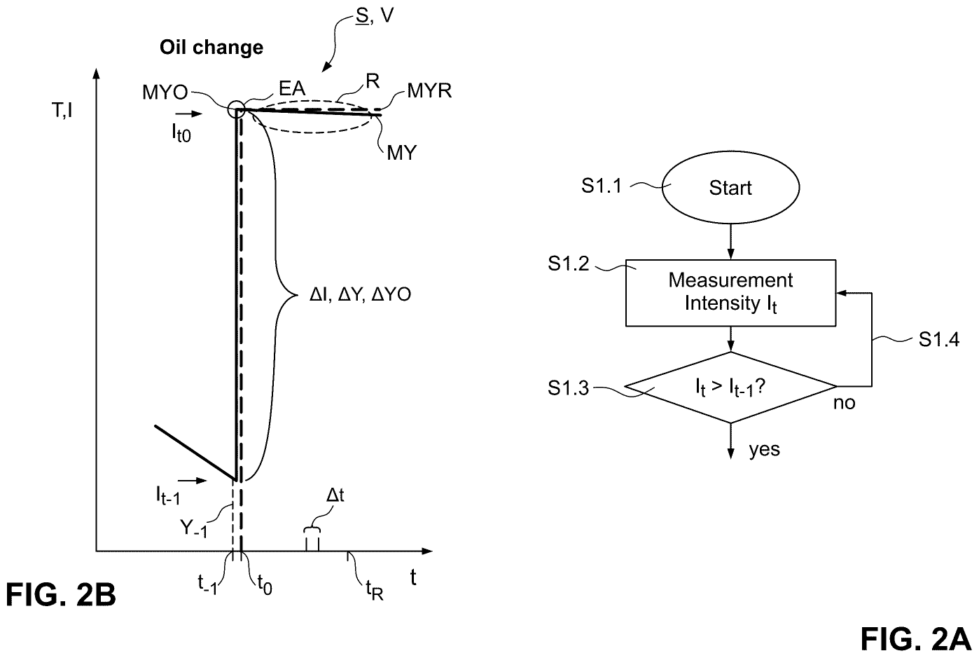

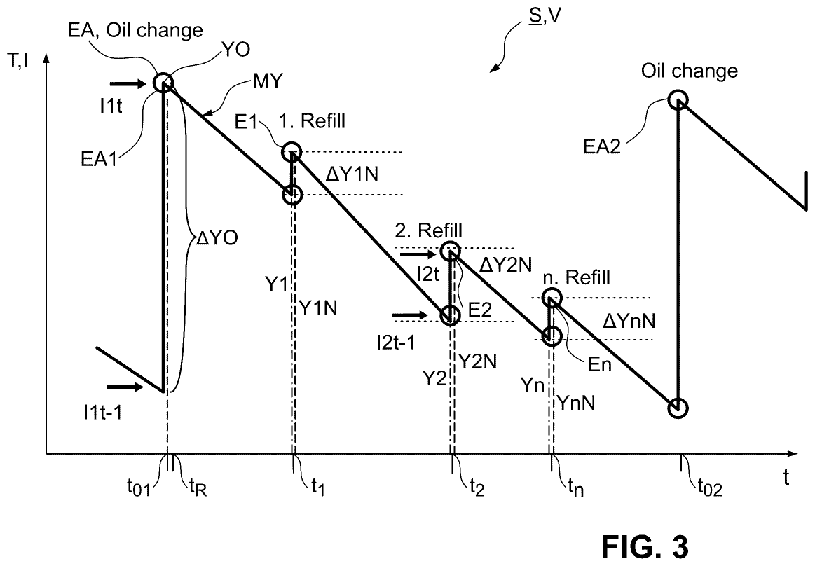

Spectroscopy device 600 with at least intensity sensor Sens_I and, if applicable, additional components of an analysis device are designed to indicate evaluable measurement signal S optionally transiently or continuously over an operating time of machine 100 transiently. In particular, in-situ measurements are taken over a very long period of the operating period, generally over the entire engine life, at regular, shorter intervals. The intervals are determined, among other things, by considering the desired or technically possible temporal resolution, for example according to the smallest possible or appropriate time step Δt. In addition, an operating period to be monitored—for example the operating time t (also see FIG. 2A, FIG. 3), after which an error or oil change in the sense of a measurable event E should be detected—can be appropriately determined.

Spectroscopy device 600 with at least intensity sensor Sens_I may be located inside machine 100 itself or can be arranged in its periphery and can at least be coupled with machine 100 for a relevant operating time in order to carry out a spectroscopic measurement analysis of operating oil BÖ by way of test radiation on operating oil BÖ.

Machine 100, in this case in the embodiment of an internal combustion engine, is also equipped with other sensors, such as in this case with at least a temperature sensor Sens_T, for determining a temperature of operating oil BÖ. In this case, machine 100 is designed according to the concept of the invention with the spectroscopy device Sens_I for determining a spectroscopic measurement result based on the spectroscopic measurement analysis of operating oil BÖ.

A spectroscopic measurement result is routinely dependent on the temperature of operating oil BÖ and is thus specified by considering the corresponding operating oil temperature; to achieve comparable measurement results, the spectroscopic measurement results are determined at an as constant as possible temperature. The measurement result is specified by considering intensity I of the spectroscopic measurement analysis, for example, determined by spectroscopy device, Sens_I and the temperature determined by temperature sensor system Sens_T. In fact, a correlation of the spectroscopic measurement result with the temperature of operating oil BÖ should be considered to avoid measurement errors. The signal intensities, especially of an infrared measurement, are routinely dependent on an oil temperature.

The signal intensity in a transmission measurement T increases with increasing oil temperature (it decreases in reflection measurement). For example, in the case of a fresh oil refill—as explained relating to FIG. 3—jumps in signal intensity I are smaller in a transmission measurement T than during an oil change. Therefore, operating oil BÖ should first be heated to operating temperature to reliably record this metrologically; this can be controlled by a temperature measurement.

However, filtered measured values cannot be rejected, but can be stored separately; for example, they can be filed in corresponding arrays (or all values can be stored in a data unit or similar file) or in an otherwise suitable manner. They could be filtered for evaluation based on temperature windows; for example, according to a temperature scheme in 5° steps.

Such values, which are assigned to the temperatures, are then evaluated as separate sets. These sets are offset from each other in the “y-axis” but should have the same tendencies.

Fundamentally, a spectroscopic measurement result can also be subjected to other physical and/or metrologically justified filters, such as the temperature filter in this case. Optical filters, which are not explained in detail here, have also proven to be advantageous for reasons of selectivity.

If, after a suitable physical and/or metrological filter application—as explained above by way of example—the aforementioned tendencies are not uniform, it can be concluded that operating oil BÖ is deteriorated. This is plausible, since in such cases a soot content in operating oil BÖ becomes significant. This can also be verified by way of a broadband spectroscopic measurement. Operating oil BÖ is more translucent at higher temperatures; this effect is no longer fully present in the case of sooting.

The explained numerical filter methods are only given as examples; other approaches of numerical implementation are possible. For example, the above-mentioned or similar shifting or stretching, in particular standardization of the signal, is possible. Smoothing, in particular averaging, or interpolation or extrapolation of the spectroscopic measurement results to specify the signal is also possible. The spectroscopic measurement results can also be subjected to a numerical frequency filter.

Overall, a measurement result of the spectroscopic measurement analysis that has been prepared in this or another suitable manner and can therefore be evaluated can be passed on for evaluation via a communication BUS or similar signaling device or can be made available on a suitable monitor device or an interface for further analysis.

In particular, a device 200 shown schematically here for signaling or for monitoring the spectroscopic measurement result determined on the basis of the spectroscopic measurement analysis is designed to communicate this to a control unit 300. Device 200 can have corresponding data interfaces and data paths that are assigned to machine 100 or are connected to it for data transmission.

Control unit 300 is designed to control temperature sensors Sens_T and spectroscopy device 600 with at least intensity sensor Sens_I in such a way that they provide an evaluable measurement signal S. Evaluable measurement signal S should be issued repeatedly over an operating time of machine 100, so that a certain condition characteristic Z for operating oil BÖ can be signaled by way of device 200.

As explained at the beginning, it can be seen that a spectroscopic measurement result MY, for example a suitable representation of an intensity I-shown in FIG. 2A or FIG. 3 as an example and explained in more detail—is to be placed in relation to a measurement reference MY0, for example to an optional intensity I0, so that an evaluable measurement signal S is to be indicated from that particular relation.

According to the embodiment in FIG. 1, a first control module 400 is provided, which is designed to evaluate spectroscopic measurement result MY regarding determination of measurement reference MY0 and/or an initial event EAn or event En (i.e. EA1, EA2 or E1, E2, etc.). In the present example, this implementation occurs optionally by determining certain differences ΔI of intensities I in transmission T as the basis of spectroscopic measurement result MY with respect to one or more threshold values Lim1, Lim2, which are only mentioned here by way of example. A further explanation is given regarding the illustrations in FIGS. 2A and 2B to FIG. 4.

In addition, a second control module 500 is provided, which is designed to issue a warning W and/or an alarm A if spectroscopic measurement result MY indicates a faulty progression or is designed in such a way that there is cause for an alarm. A fault or an alarm A would signal a deteriorating or alarming condition of operating oil BÖ in the machine.

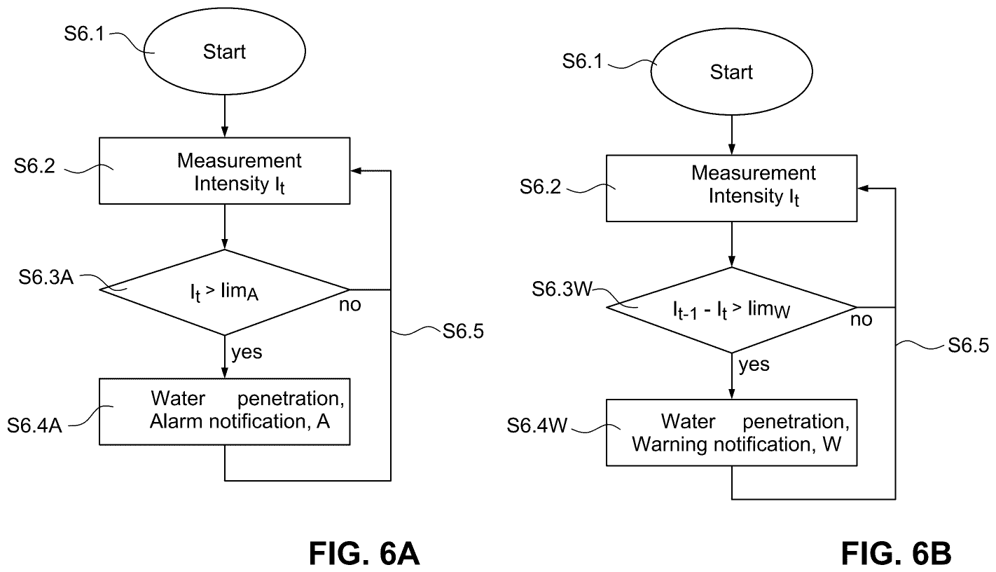

In the present case, it is stated by way of example for second control module 500 that, in the event of an alarm A, this is indicated on the basis of an intensity difference Delta_I in the sense of an erratic change amplitude ΔY of measurement signal S with respect to an alarm threshold lim_A (FIG. 6A) and that, in the event of a warning W, this is indicated on the basis of a relative intensity difference Delta_I in the sense of an erratic change amplitude ΔY of measurement signal S with respect to an error band B or a warning threshold lim_W assigned to it (FIG. 6B).

First control module 400 is explained in detail below, especially with reference to the views of FIGS. 2A and 2B to FIG. 4, specifically by way of optional design examples.

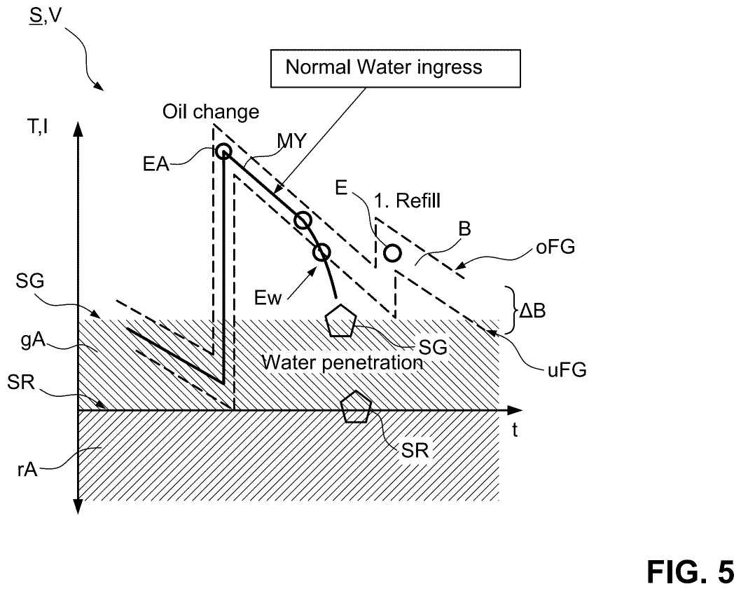

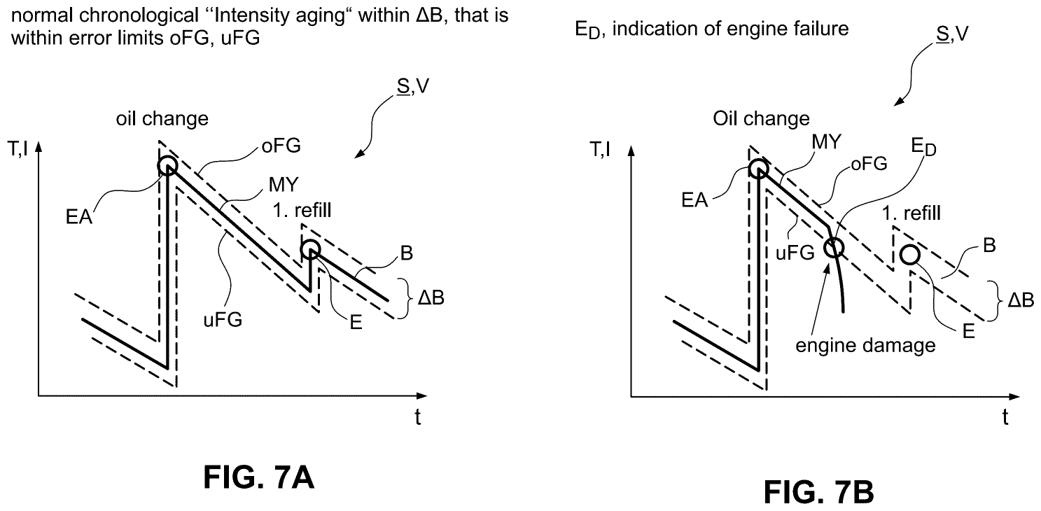

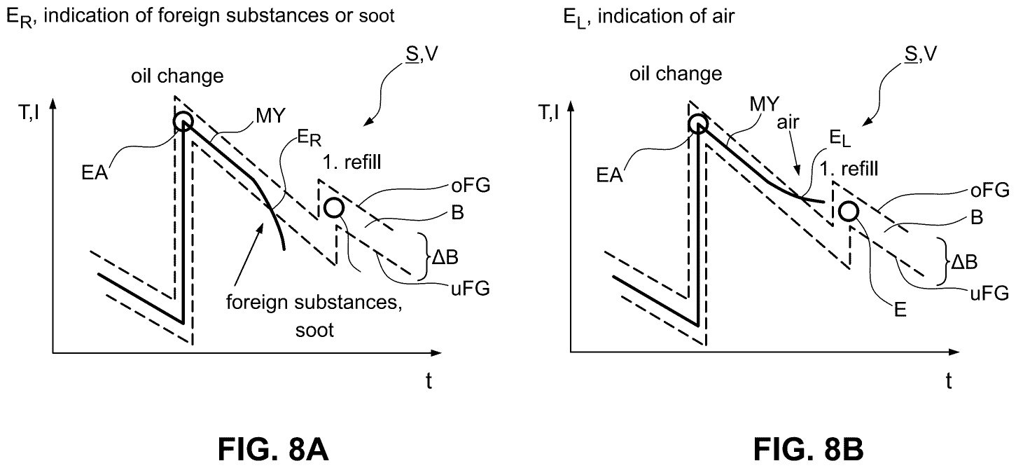

Second control module 500 is explained below, primarily on the basis of the design example in FIG. 5, the design examples in FIG. 6A, FIG. 6B and the additional design examples in FIG. 7A, FIG. 7B and FIG. 8A, FIG. 8B.

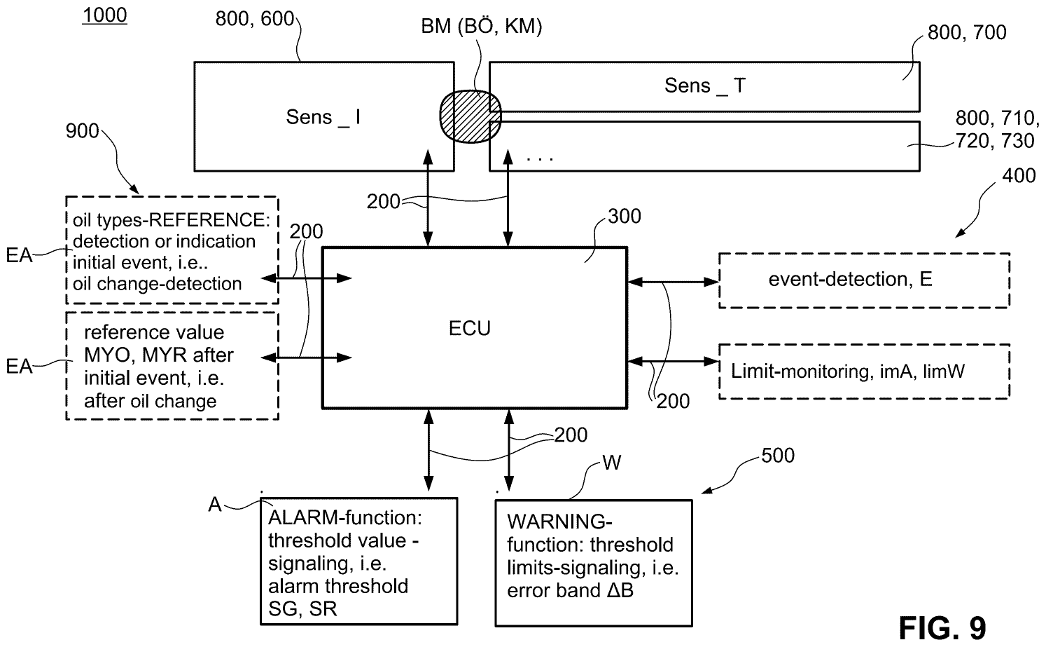

Control unit 300 is explained in detail within the framework of device 1000 with reference to FIG. 9 where it is shown schematically in individual aspects.

The following calculation shows an example of how to conduct the transmission measurement for deteriorating operating oil BÖ values—in this case, values for water in operating oil BÖ.

FIG. 2A shows an example of the progression of intensity I over operating time t with respect to control module 400, wherein intensity I is determined in transmission at operating oil BÖ. It can be seen during progression of operating time t that an oil change has occurred. After the oil change there is operating oil BÖ in machine 100, which has a higher transmission T, so that spectroscopic measurement result MY before the oil change—at time t-1—differs from that after the oil change—at time t0—by an erratic change in intensity I_t0. In other words, there is an erratic change amplitude ΔY0 assigned to the erratic change (from parameter measured value Y-1 to Y0), which is associated with a corresponding change amplitude of measurement signal S (i.e. S (Delta_I)). In this respect, this defines an initial event EA.

In the present case, an intensity I_t0 is increased erratically at time to immediately following the oil change compared to an intensity I_t-1 at a time t-1 prior to the oil change. Corresponding spectroscopic measurement result MY-assigned to intensity I_t-1—is labelled with corresponding parameter measured value Y-1, and spectroscopic measurement result MY after the oil change-assigned to intensity I_t0—is labelled with corresponding parameter measurement value Y0. Both, spectroscopic measurement results MY, that is, their corresponding parameter measurement values Y-1, Y0, are shown as dashed lines.

Event E—previously referred to as initial event EA of an oil change can herein be regarded as an initial event EA at said time t0 to indicate a measurement reference MY0 with associated parameter measurement value Y0 in relation to a spectroscopic measurement result MY.

To this end, spectroscopic measurement result MY is repeatedly determined according to the concept of the invention over a predetermined reference operating period R following the initial event EA (in the form of the oil change with respect to operating oil BÖ), that is, between a time t0 and tR as the start and end time of reference operating period R. The determination is made, for example, with 20-30 repetitions over an operating time t in time steps Δt.

For this purpose, certain spectroscopic measurement results MY are repeatedly issued in reference operating period R, that is, between times t0 and t_R. For a certain limited reference operating period R after initial event EA (in this case in the form of the oil change), which is kept short compared to the total operating period of machine 100, it can be assumed that the properties of operating oil BÖ do not change or change only negligibly.

A repetitive determination of spectroscopic measurement result MY can, for example, be used to determine a relevant measurement reference MYR from the spectroscopic measurement results MY for the reference operating period R. It can be assumed that this corresponds to the value of measurement reference Y0.

FIG. 2B shows a correspondingly suitable procedure for determining measurement reference Y0. After the indication that the initial event EA—in this case in the form of an oil change—is present, a sequence is started for the repeated determination of spectroscopic measurement result MY by measuring intensity I_t and for the indication of spectroscopic measurement result MY.

Following start step S1.1, a measurement of intensity I_t occurs on operating oil BÖ in measuring step S1.2; this is done by setting time steps Δt as close together as possible or at least with suitable time steps in accordance with a reasonable resolution for the reference operating period R and by repeatedly determining the spectroscopic measurement result MY on the operating oil BÖ.

In verification step S1.3, it is checked whether intensity I_t determined in the subsequent step is significantly greater than the previous intensity determined in step I_t-1. If this is not the case (“no”), the process returns in a loop S1.4 to measurement step S1.2, that is, intensity I_t is measured again in the next time step in order to determine a further spectroscopic measurement result MY within reference operating period R.

Spectroscopic measurement result MY is thus determined repeatedly for a reference number of repetitions, specifying a reference number of spectroscopic measurement results MY assigned to reference operating period R. Reference operating period R with respect to operating medium BM following initial event EA is determined in such a way that the reference number of spectroscopic measurement results MY is within reference operating period R.

It has become evident that the execution of this loop S1.4 up to perhaps 10 times or 20 times at comparatively small time steps Δt is suitable for determining a reliable measurement reference MY0 for operating oil BÖ in machine 100 after the oil change, that is, after the initial event EA.

The relevant measurement reference MYR can occur, for example, by subsequent averaging or other implementation of a spectroscopic or numerical filter for measurement results MY within the reference operating period R. It is to be understood that the measurement result MY can basically be a complex measurement result, for example a simple intensity or an intensity spectrum, which is determined with frequency resolution, for the reference operating period R.

If the aforementioned time values or orders of magnitude of the values are not initially known, suitable values t, I_t and I_t-1 can be stored as previously measured. A warning message can be generated on the basis of taught-in values to indicate when an oil change should take place.

If the values are known at the beginning or have been taught, especially at different points of a spectrum, it is possible to detect whether the identical type of oil is always used. If the same type of oil is used, the jumps at all points of the spectrum should be the same relative to each other. If another operating oil BÖ is refilled, the jump will not occur in the same proportion at all points (i.e. another operating oil BÖ will have a different additive).

The oil type may also be recognized when changing the oil on the basis of the specific relative changes. If an unknown operating oil BÖ is refilled, this is reported and the limits of the originally used oil are adopted for warnings.

To avoid incorrect measurements during an oil refill, the following can also be advantageously considered: When refilling the oil, portions of the fresh oil should not be directed through the sensor but should be directed past the sensor so that the existing operating oil BÖ in the oil pan and the fresh oil mix well before reaching the sensor. Alternatively, if this is not possible, the values should be considered over an interval until they reach a steady state (indicating that mixing has occurred).

In accordance with the concept of the invention, the aforementioned relevant measurement reference MYR (or in the simplest case also the measurement reference MY0, as shown here by way of example on the basis of an intensity I_t0) can thus be determined for a specific type of operating oil BÖ, in this respect replacing a calibration as previously required in the state of the art in the manner explained at the beginning. This advantageously eliminates the need for separate calibration of the properties of an operating oil BÖ; in particular, there is no need to remove operating oil BÖ from machine 100.

A determination of measurement reference MY0—or optionally, of a relevant measurement reference MYR—for operating oil BÖ can occur during operation, or at any rate while operating oil BÖ is in machine 100. This means that operating oil BÖ intended for determining the condition is in machine 100 when the condition is determined, whereby it is not absolutely necessary for machine 100 to be “running” per se.

In this regard, a spectroscopy device 600 with its own energy source, coupled to machine 100 could be used without machine 100 being in operation. For example, spectroscopy device 600 or a similar analysis device could be equipped with its own energy source, which analyzes operating oil BÖ in machine 100 during standstill of machine 100. As explained, spectroscopy device 600 can be part of a more complex measuring device 800, which in the present embodiment also has a measuring unit 700 designed for the determination of a temperature.

Operating oil BÖ could, for example, be pumped through machine 100—for example through an internal combustion engine or another engine-via a backing pump, and independently thereof a sensor of spectroscopy device 600 or similar analysis device could be operated, that is, if necessary, also independently of an ECU, 300 of machine 100. This would also be advantageous in as far as a condition determination could be made at an early stage, in other words, before operation of machine 100. In particular, water that has infiltrated could be detected earlier, since no pools of water form in operating oil BÖ, but rather water and operating oil BÖ are constantly mixed. In the present example, the sensor is an intensity sensor Sens_I as part of spectroscopy device 600, and a temperature sensor Sens-T is designed as part of measuring unit 700 for the determination of a temperature.

EXAMPLE—Calculation of the oil filling volume using the example of 100 l total volume (during oil change as an example of an initial event EA):
Y0=parameter measurement value of a measurement result MY—assigned to an intensity I_t0—after oil change (i.e. for additives) at time t0;
Yn=Parameter measurement of a measurement result MY—assigned to an intensity I_t−1—immediately prior to oil refill for refill n=1, 2, 3, . . . at time t−1;
YnN=according to the parameter measurement value of a measurement result MY immediately after oil refill for additional refill n=1, 2, 3, . . . ;
ΔYnN=difference in a parameter measurement value after oil refill; n=1, 2, 3, . . . ;
Xn=refill volume in liters, in the following example at 100 1 new oil (after oil change)
ΔYnN=YnN−Yn for refill n=1, 2, 3, . . . ; ΔY iSv change amplitude of measurement signal S

$$Xn = 100 l * ( Δ YnN / Y 0 )$$

Naturally, the 100 liters of new oil (following the oil change) referred to in example can be replaced by another variable with any amount of oil.

In the illustration of FIG. 3, a calculation is used to show schematically, by way of example, how in a transmission measurement—i.e. for a measurement of an intensity I in transmission T—deteriorating values, such as for example a proportion of water in operating oil BÖ are recognizable, and how to proceed. A result in a reflection measurement—that is, for a measurement of an intensity I in reflection R—has a correspondingly opposite, specifically complementary, progression of values (the standardized values of an intensity I in transmission T and reflection R add up to 1 and are thus complementary).

The progression of spectroscopic measurement result MY shown in FIG. 3, based on an intensity I over operating time t, results from a repeated indication of evaluable measurement result MY in such a way that a certain condition characteristic Z for operating oil BÖ can be signaled. Condition characteristic Z results from certain events E1, E2 . . . . En at time points t1, t2 . . . tn of operating time t, which are recognizable here by way of example as the first refill, second refill up to any nth refill for operating oil BÖ.

In addition to initial event EA already explained on the basis of the views in FIGS. 2A, 2B (which is referred to herein as the first initial event EA1 for a first oil change), an additional initial event EA2 in the form of an additional oil change can be recognized over the progression of operating time t at the following time t02.

For each of the further events E1 to En, representing a 1st to nth oil refill, an analogous signature can be recognized in principle, as in an oil change, but with a lower change amplitude ΔY of an erratic increase, which can be recognized by the differences in the parameter measured values ΔY1n, ΔY2n, ΔYnN, in the progression of the measurement result MY in FIG. 3.

Below follows a description as to how an oil change and an oil refill can be detected.

1) An oil change can be checked for plausibility as follows:

A large jump in the measured values of measurement result MY to values that change in the direction of new oil condition means “oil change”; a small jump to “better” measured values (towards new oil condition) means “oil has been refilled”.

The number of hours of operating time t is recorded with the data logger, even across oil changes. A “large” jump serves as a marker that an oil change has occurred and is accordingly marked in the data logger as a reference measurement. All values that change significantly during an oil change are suitable for this, as the properties of the oil change with age, for example, in that additives decrease, or 80 acid or base values change, or turbidity increases, thereby reducing the signal intensity at reference points. With regard to turbidity, measuring points whose wavelengths are not absorbed by existing molecules but are purely a measure of the opacity of the oil are used as a “signal reference”.

2) In the case of an oil refill, the refill volume can be checked for plausibility as follows:

The estimation is carried out on the basis of measurement criteria that can be verified by way of measurement technology.
a) The first measured value or measured values averaged over several 90 measurements at short intervals (i.e., one measurement every ½ hour over 10 measurements) immediately after the oil change are used as a basis.
b) In order to quantify the refill volume, the total volume of oil present in the engine must be known.
c) A refill results in a “small” jump in the measured values. This “small” jump is set in relation to a “large” jump (during an oil change), from which the refill volume is calculated.
d) Optionally, the refill volume can be checked for plausibility with an electrical oil level sensor (when the engine is at a standstill and at a defined temperature), if available.

Suitable for this method are measured substances that cannot be influenced by external changes during engine operation and whose values are proportional to the refilled volume. The following are typically suitable:
Additives: These are suitable because they only increase again when fresh oil is refilled, provided that the same type of oil is used.
Sulfates: This is on the assumption that the engine is operated with low-sulfur fuel in accordance with standard (i.e. DIN 110 EN 590). If fuel containing sulfur is used, sulfates cannot be used for the assessment.

Less suitable or unsuitable are aspects such as, for example:
Water: It is produced during combustion and, to a small extent, can still get as a blow-by past the piston rings into operating oil BÖ due to high humidity in the cylinder during combustion.

In addition, many engine starts and short engine running times increase the water content in the oil.
Base number, acid number: As explained above, this is influenced by additional chemical reactions during combustion, depending on engine operation (especially the combustion air ratio), fuel quality, engine condition (for example aging of the piston rings), and these values change accordingly. In addition, the operating temperature plays a role and, depending on the environment, also the atmospheric composition.
Oxidation, nitration: These are too dependent on engine operation, fuel quality, engine condition and environmental conditions.

Moreover, a pure intensity measurement in an infrared measuring range in which optically active substances are not present or do not have to be present is especially suitable. The intensity decrease occurs purely on the basis of the measurement of turbidity in operating oil BÖ, as can be seen, for example, in the graph for progression V of evaluable measurement signal S in FIG. 3, this being under consideration of the reference measurement in reference operating period R as shown and explained by the views of FIGS. 2A, 2B.

An oil refill in the area of event E1 . . . En is recognizable by a value of the increase that is above a second limit value lim2 for the measured intensity as the basis for spectroscopic measurement result MY, wherein this second limit value is lower than limit value lim2 for an initial event EA1, EA2 of an oil change.

On the one hand, this allows the determination of an oil change as an initial event EA1, EA2 or as a simple event E. This moreover allows the determination of an oil refill as one or a number of events E1 to En. By distinguishing an intensity difference Delta_I in the sense of an erratic change amplitude ΔY of measurement signal S with respect to amplitude value lim2—as a lesser amplitude value lim2 compared to the greater amplitude value lim1—it allows the distinction between an oil change (assigned to a greater change amplitude ΔY of measurement signal S above amplitude value lim1) and an oil refill (with a lesser change amplitude ΔY of measurement signal S above the lesser amplitude value lim2).

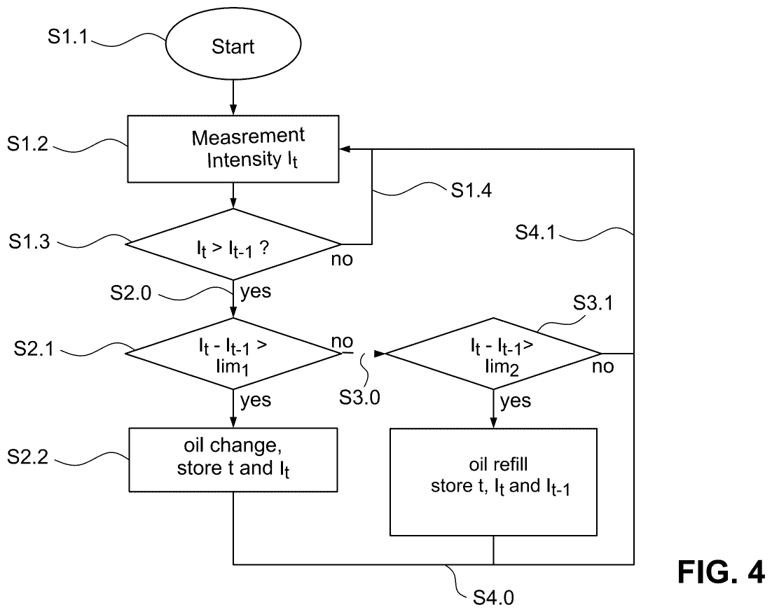

A corresponding flow chart of a method for determining the condition of operating oil BÖ in engine 100—as can be performed in the first control module 400 shown in FIG. 1—is illustrated in FIG. 4; an oil change detection or similar detection of an initial event EA and a further event E occurs therein.

The previously explained determination of measurement reference MY0 after an initial event EA in the form of a first oil change (first initial event EA1 or second initial event EA2) is a part of this process sequence in the design example in FIG. 4. Regarding steps S1.1 to S1.4 in the process sequence, reference is made to the process sequence as described in the design example of the views in FIGS. 2A, 2B, in particular, with regard to view FIG. 2B.

In the event that it is recognized in step S1.3 that the change amplitude has increased in intensity I_t compared to intensity I_t-1 in the previous step—in other words, if transmission T has increased—step S2.0 transitions (“yes”) to query the previously explained limit values lim1, lim2 as a greater and lesser amplitude value.

In step S2.1 it is queried whether the follow-up intensity I_t exceeds the previously determined intensity I_t-1 by a first limit value lim1. Specifically, it is queried whether the change amplitude ΔY or S (I_t-I_t-1) of measurement signal S exceeds first limit value lim1 as a greater amplitude value. If this is the case (“yes”), an oil change is detected in step S2.2, and the associated operating time t and intensity I_t for this or measured value MY is stored as measurement reference MY0 (see design example in the views of FIGS. 2A, 2B).

If, in contrast, the query is denied (“no”) in step S3.0, it is checked in step S3.1 whether the subsequent intensity I_t at time t exceeds the previously measured intensity I_t-1 by another, second limit value lim2. Specifically, it is queried whether change amplitude ΔY or S (I_t-I_t-1) of measurement signal S exceeds second limit value lim2 as a lesser amplitude value. In this case, when measured as transmission T, second limit lim2 is less than the first limit lim1.

This situation applies, for example, to operating times t1, t2 and tn with the available spectroscopic measurement results MY; in other words, in each case after oil refilling according to parameter measured values Y1, Y1N or Y2, Y2N or Yn, YnN, etc. Hence, if an intensity change ΔI1, ΔI2, ΔIn measured there or the corresponding erratic change in the measurement result MY, or the difference between parameter measurement values ΔY1N, ΔY2N, ΔYnN in terms of a change amplitude ΔY or S (I_t-I_t-1) of measurement signal S exceed the second limit value lim2, an oil refill is inferred and the corresponding operating time t with intensity values I_t and I_t-1 or the corresponding amplitude of the measurement signal S is saved.

Subsequently, the process is then directed to the next time step with a further step S4.0, in which another measurement of intensity I_t+1 is performed. This is also the case if the query in step S3.1 (“no”) is not answered positively, so that step S4.1 returns the process to the beginning to measurement step S1.2.

The presentation in FIG. 5 illustrates a detection of water ingress into operating oil BO. In FIG. 5, the example of the measurement of transmission T shows that signal S of a spectroscopic measurement result MY decreases with increasing contamination of operating oil BÖ in the overall trend. With an oil change or oil dilution, the contamination would be progressively lower and there would be a signal jump to high transmission as explained by FIG. 4, or at least an increasing signal tendency for the spectroscopic measurement result MY.

Moreover, FIG. 5 also shows an initial event EA of an oil change and a (predicted) event E of an oil refill as examples.

FIG. 5 shows an exemplary signal progression V for signal S analogous to FIG. 2A and FIG. 3, wherein a water penetration in the signal progression is also recognizable as an event E_W, and the signal progression falls below a lower error limit uFG of a trend band B with upper and lower error limits oFG, uFG. This leads to issuing of a warning W.

In the present example, the cooling water ingress is detected by a transmission measurement T, in which measurements are taken at an infrared frequency for water and, if necessary, also at the infrared frequency of i.e. sodium (coolant additive). Similarly, a reflection measurement would be possible, with qualitatively analogous criteria, as explained herein by way of an example of a transmission measurement T. The measurement is relatively related to time t, as operating oil BÖ absorbs water slowly through the ambient air and through the water produced during combustion, via “blow-by” past the piston rings.

In the example of water ingress by way of intensity measurement (possibly without the option of a trend band B or a lower or upper error limit uFG, oFG) according to FIG. 5, the spectroscopic measurement result Y finally falls below a first lower threshold value SG; a yellow alarm gA occurs. If the second lower threshold value SR has fallen below, red alarm rA occurs. For each type of alarm and depending on the application, appropriate measures can be initiated, up to and including automated engine shutdown.

Similarly, an absorption spectrum that is quasi-inverted can also be used. The signal would then increase due to increasing contamination as a function of time in the overall trend. When the oil is changed, the signal jumps downwards, as the absorption is very low due to the reduced contamination; the alarms would then be adjusted accordingly.

In this context, FIG. 6A generally shows a flowchart for a first embodiment of a process for providing an alarm indication, and FIG. 6B shows a flowchart for a first embodiment of a process for providing a warning indication. A corresponding controller includes a module 500 (as shown and explained in FIG. 1) by way of which a warning and/or alarm condition for an operating oil BÖ present in a machine can be more reliably detected.

After a first start step S6.1, an intensity I is measured on the operating oil BÖ by the spectroscopy device 600 with at least the intensity sensor Sens_I in step S6.2. In test step S6.3A or S6.3W, this is checked for a condition. For the second control module 500, it is given as an example that this is specified on the basis of an intensity difference with respect to an error band or an intensity difference with respect to an alarm threshold; that is, test step S6.2A checks for the intensity I_t absolute with respect to the alarm threshold limA, that is, the alarm threshold yellow alarm SG or red alarm SR—in the embodiment described herein, the first and second lower threshold values SG, SR—whereas test step S6.2B examines intensity I_t relative to a deviation with respect to an error deviation ΔB of trend band B. The error deviation ΔB is essentially determined by the aforementioned lower or upper error limit uFG, oFG.

It can be seen that an alarm notification A in step S6.4A basically only occurs when a threshold value lim_A is exceeded by an absolute value of the intensity I_t or the associated measurement signal S, whereas a warning notification in step S6.4W already occurs when a warning threshold lim_W is exceeded, according to the specified error limits uFG, oFG, by a difference or similar relative value of the intensity I_t-1-I_t or the associated difference of measurement signals S.

The process is executed as a loop with a feedback step S6.5 to measuring step S6.2.

FIG. 7A, FIG. 7B and FIG. 8A, FIG. 8B show further exemplary signal progressions analogous to FIG. 5, wherein another event in the signal progression is also recognizable and the signal progression falls below a lower error limit uFG of a trend band B. This leads to a warning being issued.

To begin with, FIG. 7A shows the known trends of an oil contamination for normal operation based on a transmission measurement T. Accordingly, upper, and lower error limits oFG, uFG of a trend band B can optionally be set, as already explained in FIG. 5. If these upper and/or lower error limit oFG, uFG are fallen below or exceeded as an error limit progression, the operator can be notified (i.e. via a display) that something unusual is occurring on machine 100 or on a similar equipment that must be checked. In addition to, or as an alternative to error limits uFG, oFG, a gradient progression can also be used.

Exceeding a trend band B can already lead to an early notification signal, which serves to provide an early warning W of an anomaly in the oil condition when an upper or lower error limit oFG, uFG of the trend band B is exceeded. In other words, it is advantageous that such an early warning can be provided well before an alarm A (perhaps a yellow alarm gA or red alarm rA with fixed threshold values), since an alarm, in turn, only occurs based on static criteria (and thus possibly too late).

In an alarm condition of operating oil BÖ, an engine or a technical system or also machine 100 may already be at risk due to an oil condition that has already deteriorated too much. It is apparent that a basis for the trend band B is the elimination of measurement, production and temperature tolerances in operating oil BÖ. This is ensured by the inventive determination of the measurement reference from the spectroscopic measurement results.

Thus, the production tolerance is already eliminated by the reference intensity; operating oil (BÖ) is assumed to be the oil that is in the engine.

The temperature tolerance can be measured and can thus be considered. Accordingly, a temperature can be measured within the framework of a complex measuring device 800 with measuring unit 700 which is shown and explained in FIG. 1 and FIG. 9, and which is designed to determine a temperature and has a temperature sensor Sens_T here. Additional tolerances, such as water ingress or the like, can also be learned, for example, based on empirical values or the like. Additional measuring units can also be provided within the framework of complex measuring device 800.

An aforementioned trend band itself also serves specifically to accommodate these tolerances. In the present example, these tolerances are moreover eliminated, meaning that oil condition determination and monitoring are significantly more accurate, and the tolerance band is thus designed with particular precision to indicate early signs of oil deterioration.

FIG. 7B illustrates the detection of diesel fuel in operating oil BÖ. This is recognizable as an additional event E_D in the signal progression; and the signal progression falls below a lower error limit uFG of a trend band B.

The described method, using error limits uFg, oFG of trend band B can be applied additionally or alternatively analogously with a gradient determination.

Fuel ingress can be detected, for example, by a rapid drop in oil additives such as zinc, barium, boron, calcium, magnesium or phosphorus-depending on the basic additive content in the oil.

The signal changes in the event of impending engine damage are as follows:
Rapid signal change due to dilution of the oil;
Rapid signal change due to temperature change of the oil if the temperature difference between water or fuel is relatively large compared to the engine oil.

The signal trend is determined by gradient determination. As a rule, the trend of a decrease in additives is known on the basis of recordings over a longer period of time, as these are stored in modern devices for days/weeks. If the gradient changes significantly from the previous recordings within a specified time interval, an alarm occurs.

By way of an example of a transmission measurement FIG. 8, illustrates the detection of contamination and/or soot and/or substances in operating oil BÖ that are not within the sensor range. This is recognizable as an additional event E_R in the signal progression, and the signal progression falls below a lower error limit uFG of a trend band B.

A broadband measurement is possible instead of just one band (measurement parameter), since soot is generally infrared active.

Alternatively, narrowband ranges can be used that are not in the range of the substances to be examined (water, nitrates, sulfates, etc.) but only react to soot (infrared active) and contamination (transmission or absorption intensity).

If narrowband spectrum bands of a spectrum of the measured radiation “outside of the specifically examined substances” (as mentioned above) show no change or only a slight change, then there was ingress of an unknown substance. However, in cases of severe turbidity, that is, a sharp drop in intensity I during transmission measurement T, it is usually soot, as this affects many wavelengths in the spectrum of the transmitted measured radiation.

Signal intensity is also a measure of oil contamination. Analogous to the procedure for oil aging, signal intensity can be used as an additional measurement indicator. If the intensity decreases within the specified error limits of oFG, uFG, or if a gradient decreases relatively uniformly, then this is a case of normal aging of the oil. If one or more parameters decrease very rapidly, then it is more likely an engine problem. It should be considered that the opacity of the oil decreases when the oil is refilled.

FIG. 8B exemplifies an indication of air by way of an example of a transmission measurement. This is recognizable as an additional event E_L in the signal progression and the signal progression exceeds an upper error limit oFG of a trend band B.

Often there is air in the oil which causes a signal jump at all measuring points. If the jump can only be observed at one measuring point, then a foreign substance is introduced. In the case of air, the transparency of the oil is higher and the signal intensity increases during transmission measurement. In the case of foreign substances, the turbidity of the oil increases and the signal intensity decreases due to refraction.

FIG. 9 shows a specific schematic diagram of a control and measuring system 1000 in detail with the demonstrated functionality for determining an oil condition according to an optional further development.

Based on FIG. 1, an optional embodiment of a device 1000 according to the concept of the invention is shown in an overview in FIG. 9, namely control unit ECU 300 and, within the framework of a complex measuring device 800, a spectroscopy device 600 with an intensity sensor Sens_I and a measuring unit 700 designed for determination of a temperature, which in this case has a temperature sensor Sens_T and, if necessary, one or more further measuring units 710, 720, 730 each for the determination of a viscosity, turbidity, or density of operating medium BM.

Device 1000 has a corresponding device 200 for signaling or monitoring or the like for indicating or displaying a condition of an operating oil BÖ present in the machine. Communication between control unit ECU 300 and the other components of device 1000 is bidirectional by way of device 200 for signaling or monitoring.

Device 1000 is designed to perform the method for determining the condition of an operating medium BM located in a machine 100, especially, however, not exclusively of an operating oil BÖ, in particular, with an oil change detection or similar detection of an initial event EA or another event E.

Device 1000 is designed in particular with a supply of operating oil BÖ of the machine to a spectroscopy device 600 coupled to the machine with the intensity sensor Sens_I (not shown here). In addition, spectroscopy device 600 with intensity sensor Sens_I is designed to perform a spectroscopic measurement analysis by way of a test radiation of the spectroscopy device and to determine a spectroscopic measurement result MY based on the spectroscopic measurement analysis.

Device 1000 is also equipped with a calculation module which is accommodated, for example, in control unit 300, and which allows spectroscopic measurement result MY to be set in relation to a measurement reference MY0 or relevant measurement reference MYR in such a way that an evaluable measurement signal S is specified from said relation. For example, the evaluable measurement signal S can be specified repeatedly over an operating time t of machine 100 in such a way that a certain condition characteristic Z can be signaled for operating oil BÖ.

Also, a reference module 900 is provided, which is designed—as explained with reference to the views in FIGS. 2A, 2B—to repeatedly determine spectroscopic measurement result MY over a predetermined reference operating period R following an initial event EA in relation to operating oil BÖ, specifying spectroscopic measurement results MY associated with reference operating period R, and to determine measurement reference MY0, MYR from the spectroscopic measurement results. This can also be used, for example, to determine an oil type, for example.

Reference module 900 is moreover designed to select the initial event EA with regard to the operating oil as an initial event EAn with respect to the operating oil BÖ or similar operating medium BM, which is intended or suitable for determining the particularly relevant measurement reference MY0, MYR, in particular in form of an oil change, but if necessary, also an oil refill. Reference module 900 is designed to establish the initial event EA with respect to operating oil BÖ in such a way that it is checked whether measurement signal S for an event time window exhibits an erratic change in the sense of a change amplitude S (Delta_I) of measurement signal S.

Device 1000 also has a first control module 400, which is designed to evaluate spectroscopic measurement result MY with a view to determining a particularly relevant measurement reference MY0, MYR and/or an event E; in the present case, this implementation optionally occurs by establishing certain intensity differences ΔI as the basis of spectroscopic measurement result MY with respect to one or more limit values lim1, Lim2.

First control module 400 is designed in particular to identify an abrupt change amplitude S (Delta_I) of measurement signal S assigned to the abrupt change if this exceeds or passes a first event threshold value lim1, so that the initial event or another event can be identified as an oil change. In particular, first control module 400 is designed to identify an erratic change amplitude associated with the erratic change if it exceeds or passes a second event threshold lim2, so that the initial event or another event can be identified as an oil refill. The first event threshold value lim1 exceeds the second event threshold value lim2 in the case of a transmission measurement.

The device or control and measuring device 1000 also has a second control module 500, which is designed to issue a warning W and/or an alarm A if spectroscopic measurement result MY indicates an erroneous progression or is designed in such a way that there is cause for an alarm; a fault or alarm A would signal a deteriorating or alarming condition of the operating oil in machine 100.

In the present case, it is stated by way of example for the second control module 500 that, in the case of an alarm A, this is issued on the basis of an intensity difference Delta_I or an associated change amplitude S (Delta_I) of measurement signal S with respect to an alarm threshold value limA (shown in FIG. 6A), and that, in the case of a warning W, this is issued on the basis of a relative intensity difference Delta_I or an associated change amplitude S (Delta_I) of measurement signal S in relation to a trend band B or its error deviation ΔB is specified (FIG. 6B). In particular, second control module 500 is designed to specify an upper and/or lower error limit oFG, uFG over operating time t for the repeatedly specified evaluable measurement signal S, in particular, to specify the upper and/or lower error limit oFG, uFG as an error limit progression over a progression of evaluable measurement signal S over operating time t, which specify an optional progression V of the evaluable measurement signal S.

### LIST OF REFERENCE SYMBOLS

100 machine
200 device for signaling or monitoring or for similar actions for issuing or displaying a condition of an operating oil in the machine
300 control unit
400 first control module
500 second control module
600 spectroscopy device
700 temperature measuring unit
710, 720, 730 additional measuring unit to respectively determine viscosity, turbidity or density of operating medium BM
800 measuring device
900 reference module
1000 device
Sens_I intensity sensor
uFG, oFG lower, upper error limit
I_t-1-I_t intensity
W warning
A alarm A
gA, rA yellow alarm, red alarm
SG first lower threshold value, alarm threshold yellow alarm
SR second lower threshold value, alarm threshold red alarm
lim_A lim_W warning threshold for alarm A or warning W
BM, BÖ, KM operating medium, operating oil, coolant
MY measurement result, intensity I
MY0 measurement reference
B trend band,
ΔB error deviation
S evaluable measurement signal
E, En, E1, E1 event, operating oil refill
EAn, EA1, EA2 initial event, operating oil change
R reference operating period
Z condition characteristic
V progression
Y-1, Y0 parameter measured value
ΔY, ΔY0, S(Delta_I) change amplitude associated with an erratic change or change amplitude of measurement signal S
Delta_I intensity difference
lim2 lesser amplitude value
lim1 greater amplitude value
t0 time after oil change, beginning of reference operating period R
tR End of reference operating period R
t-1 time before oil change
t operating time
Δt time step, resolution
I_t-1, I_t0, I1t-1, I1t, I2t-1, I2t intensities

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method to determine a condition of an operating medium in a machine, the method comprising the steps of:
supplying the operating medium for the machine to a spectroscopy device coupled to the machine;
performing a spectroscopic measurement analysis by way of a test radiation of the spectroscopy device;
determining a spectroscopic measurement result based on the spectroscopic measurement analysis; and
setting the spectroscopic measurement result in relation to a measurement reference, with the result that an evaluable measurement signal is issued, wherein the spectroscopic measurement result is repeatedly determined over a predetermined reference operating period following an initial event with regard to the operating medium specifying a plurality of spectroscopic measurement results assigned to the predetermined reference operating period, and the measurement reference is determined from the plurality of spectroscopic measurement results, and the evaluable measurement signal is repeatedly specified over an operating time of the machine in such a way that a specific condition characteristic for the operating medium can be signaled.

2. The method according to claim 1, wherein the operating medium is at least one of an operating oil and a coolant.

3. The method according to claim 1, wherein the spectroscopic measurement result is determined repeatedly for a reference number of repetitions specifying a reference number of spectroscopic measurement results assigned to the predetermined reference operating period, and the predetermined reference operating period following the initial event with respect to the operating medium is determined such that the reference number of spectroscopic measurement results is within the predetermined reference operating period.

4. The method according to claim 3, wherein the spectroscopic measurement result is checked whether the spectroscopic measurement result is essentially unchanged for the reference number of repetitions, wherein the reference number of spectroscopic measurement results is within a predetermined constant range, and wherein the measurement reference is determined from the reference number of spectroscopic measurement results—which are essentially unchanged—of the predetermined reference operating time period.

5. The method according to claim 1, wherein the spectroscopic measurement result is provided with a test radiation of a predetermined spectrum for at least one test radiation line, for a plurality of test radiation lines, or for a spectrum band of the test radiation.

6. The method according to claim 1, wherein at least one of (a) the spectroscopic measurement result is subjected to an optical filter and (b) the evaluable measurement signal is subjected to a numeric filter.

7. The method according to claim 1, wherein the initial event in relation to the operating medium is suitable for determining the measurement reference with respect to the operating medium, and wherein the initial event is selected from a group consisting of a change of the operating medium and a refilling of the operating medium.

8. The method according to claim 1, wherein the initial event with respect to the operating medium is determined by checking whether the evaluable measurement signal indicates an erratic change for an event time window.

9. The method according to claim 8, wherein an erratic change amplitude assigned to the erratic change exceeds a first event threshold value.

10. The method according to claim 9, wherein the erratic change amplitude assigned to the erratic change exceeds the first event threshold value in a form of a comparatively greater amplitude value, wherein the initial event or another event is identified as an operating medium change.

11. The method according to claim 8, wherein an erratic change amplitude assigned to the erratic change exceeds a second event threshold value.

12. The method according to claim 11, wherein the erratic change amplitude assigned to the erratic change exceeds the second event threshold value in a form of a comparatively lesser amplitude value, wherein the initial event or another event is identified as an operating medium refill.

13. The method according to claim 8, wherein an erratic change amplitude assigned to the erratic change exceeds a first event threshold value, wherein the erratic change amplitude assigned to the erratic change exceeds a second event threshold value, and wherein the first event threshold value exceeds the second event threshold value.

14. The method according to claim 1, wherein at least one of an upper error limit and a lower error limit are specified over the operating time for the evaluable measurement signal that is repeatedly specified.

15. The method according to claim 1, wherein at least one of:
(a) the evaluable measurement signal is issued over the operating time of the machine to represent a progression, wherein by way of the progression the specific condition characteristic for the operating medium can be signaled; and
(b) at least one of an upper error limit and a lower error limit are specified as an error limit progression based on a progression of the evaluable measurement signal over the operating time.

16. The method according to claim 1, wherein the specific condition characteristic of the operating medium can be signaled with regard to an event selected from a group consisting of a change of the operating medium, a refill of the operating medium, an ingress of water into the operating medium, an ingress of fuel into the operating medium, and an ingress of at least one of contamination and soot into the operating medium.

17. A device for a machine, the device comprising:
the device, which is configured for carrying out a method to determine a condition of an operating medium in the machine, the method including the steps of:
supplying the operating medium for the machine to a spectroscopy device coupled to the machine;
performing a spectroscopic measurement analysis by way of a test radiation of the spectroscopy device;
determining a spectroscopic measurement result based on the spectroscopic measurement analysis; and
setting the spectroscopic measurement result in relation to a measurement reference, with the result that an evaluable measurement signal is issued, wherein the spectroscopic measurement result is repeatedly determined over a predetermined reference operating period following an initial event with regard to the operating medium specifying a plurality of spectroscopic measurement results assigned to the predetermined reference operating period, and the measurement reference is determined from the plurality of spectroscopic measurement results, and the evaluable measurement signal is repeatedly specified over an operating time of the machine in such a way that a specific condition characteristic for the operating medium can be signaled.

18. The device according to claim 17, wherein the device is a control and measuring device for the machine.

19. A machine, comprising:
a device, which is a control and measuring device, the device being configured for carrying out a method to determine a condition of an operating medium in the machine, the method including the steps of:
supplying the operating medium for the machine to a spectroscopy device coupled to the machine;
performing a spectroscopic measurement analysis by way of a test radiation of the spectroscopy device;
determining a spectroscopic measurement result based on the spectroscopic measurement analysis; and
setting the spectroscopic measurement result in relation to a measurement reference, with the result that an evaluable measurement signal is issued, wherein the spectroscopic measurement result is repeatedly determined over a predetermined reference operating period following an initial event with regard to the operating medium specifying a plurality of spectroscopic measurement results assigned to the predetermined reference operating period, and the measurement reference is determined from the plurality of spectroscopic measurement results, and the evaluable measurement signal is repeatedly specified over an operating time of the machine in such a way that a specific condition characteristic for the operating medium can be signaled.
